(19) United States
(12) Patent Application Publication
(10) Pub. No.: US 2018/0247536 A1
(43) Pub. Date: Aug. 30, 2018

(54) METHOD AND SYSTEM FOR OPERATING A PARKING AREA

(71) Applicant: Robert Bosch GmbH, Stuttgart (DE)

(72) Inventors: Manuel Maier, Esslingen (DE); Stefan Nordbruch, Kornwestheim (DE)

(21) Appl. No.: 15/756,857

(22) PCT Filed: Jul. 12, 2016
(86) PCT No.: PCT/EP2016/066522

§ 371 Date: Mar. 1, 2018

(30) Foreign Application Priority Data
Sep. 3, 2015 (DE) 10 2015 216 889.1

(51) Int. Cl. G08G 1/14; G08G 1/017; G07C 9/00

(52) U.S. Cl. CPC G08G 1/149; G08G 1/146; G07C 9/00896; G07C 9/00111; G08G 1/017

(57) ABSTRACT

A method for operating a parking area that includes a plurality of parking spaces and a plurality of parking occupancy sensors for acquiring a respective state of occupancy of each of the parking spaces, including the following steps: determination, using a parking occupancy sensor, of whether a parking space is free or is occupied by a motor vehicle, if the parking space is occupied by a motor vehicle, testing of whether the parked motor vehicle is permitted to park within the parking area, and if the motor vehicle is not permitted to park within the parking area, controlling of one or more actions in order to make it possible to bring about a removal of the parked motor vehicle. A corresponding system, a corresponding parking area, and a computer program are also described.

### FIELD

The present invention relates to a method and a system for operating a parking area. In addition, the present invention relates to a parking area, and to a computer program.

### BACKGROUND INFORMATION

Conventional parking occupancy sensors can acquire a state of occupancy of a parking space.

A parking area is a spatially limited region within which there are situated a plurality of parking spaces at which motor vehicles can park. For example, in cities there are parking areas in which only residents are permitted to park. That is, the residents are permitted to park their motor vehicles at any parking space of the parking area.

### SUMMARY

An object of the present invention is to provide an efficient design for the efficient operation of a parking area.

Advantageous embodiments of the present invention are described herein.

According to one aspect, a method is provided for operating a parking area that includes a plurality of parking spaces and a plurality of parking occupancy sensors for acquiring the respective state of occupancy of the parking spaces, the method including the following steps:
determination, using a parking occupancy sensor, of whether a parking space is free or is occupied by a motor vehicle,
if the parking space is occupied by a motor vehicle, testing whether the parked motor vehicle is permitted to park within the parking area, and
if the motor vehicle is not permitted to park within the parking area, controlling of one or more actions in order to make it possible to bring about a removal of the parked motor vehicle.

According to another aspect, a system is provided for operating a parking area that includes a plurality of parking spaces, the system including:
a plurality of parking occupancy sensors for acquiring a respective state of occupancy of the parking spaces in order to determine whether the parking spaces are free or are occupied by a parked motor vehicle,
a testing device for testing, in case a parking space is occupied by a motor vehicle, whether the parked motor vehicle is permitted to park within the parking area, and
a control device for controlling one or more actions in order to make it possible to bring about a removal of the parked motor vehicle if the motor vehicle is not permitted to park within the parking area.

According to another aspect, a parking area is provided including a plurality of parking spaces and the system for operating a parking area.

According to a further aspect, a computer program is provided that includes program code for carrying out the method for operating a parking area when the computer program is executed on a computer.

The present invention thus includes, in particular and inter alia, determining, using a parking occupancy sensor, whether a parking space monitored by the parking occupancy sensor is free or is occupied by a motor vehicle. If the parking space is occupied by a motor vehicle, that is if a motor vehicle is parked in the parking space, it is checked whether this is permissible. That is, it is checked whether the parked motor vehicle is permitted to park within the parking area. If the motor vehicle has been impermissibly parked within the parking area, then one or more actions are controlled, in particular introduced, in order to make it possible to bring about a removal of the parked motor vehicle.

In this way, in particular the technical advantage is brought about that impermissibly parked motor vehicles can be efficiently removed. In this way, in addition in particular the technical advantage is brought about that a parking area can be efficiently operated. In particular, in this way the technical advantage is brought about that an impermissibly parked motor vehicle does not block other vehicles in the act of parking that are permitted to park within the parking area.

In the sense of the present invention, vehicles are motor vehicles.

A motor vehicle that is permitted to park within the parking area may therefore permissibly be parked within the parking area. Such a parked motor vehicle may be designated a permissibly parked motor vehicle.

A parked motor vehicle that is not permitted to park within the parking area may be designated an impermissibly parked motor vehicle.

A parking space at which no motor vehicle is parked may be designated a free parking space. The corresponding state of occupancy is therefore free, i.e., a free state of occupancy. That is, the parking space is free.

A parking space at which a motor vehicle is parked may be designated an occupied parking space. The corresponding state of occupancy is thus occupied, i.e., an occupied state of occupancy. That is, the parking space is occupied.

According to a specific embodiment, it is provided that the testing includes the acquisition of an identifier of the parked motor vehicle, the acquired identifier being compared with reference identifiers of motor vehicles that are permitted to park within the parking area, so that, based on the comparison, it is determined whether the parked motor vehicle is permitted to park within the parking area.

In this way, in particular the technical advantage is brought about that the testing can be efficiently carried out. This is because in this way for example a comparison of the acquired identifier to reference identifiers can efficiently be carried out using an electronic processing device, for example a computer.

According to a specific embodiment, it is provided that the identifier includes a license plate of the motor vehicle and/or a chassis number of the motor vehicle.

In this way, in particular the technical advantage is brought about that the identifier is usually unambiguous. This is because, as a rule, for each motor vehicle only one unique chassis number or one unique license plate exists.

Thus, in this case the reference identifiers include for example reference license plates and/or reference chassis numbers.

According to a further specific embodiment, it is provided that the acquisition of the identifier includes the reception of the identifier from the vehicle, using the parking occupancy sensor.

In this way, in particular the technical advantage is brought about that the identifier can be efficiently acquired. This is done in particular in that the vehicle sends its identifier to the parking occupancy sensor. The parking occupancy sensor thus receives the identifier sent by the vehicle.

The sending, or the receiving, i.e., in general a communication between the vehicle and the parking occupancy sensor, is carried out in particular via a communication network.

According to a specific embodiment, the communication network includes a WLAN communication network and/or a mobile radiotelephone network and/or a communication network according to the LoRa standard. “LoRa” stands for “Low Power Wide Range Communication.” According to a specific embodiment, the communication network thus includes a LoRa communication network.

According to a specific embodiment a communication via the communication network is encrypted.

According to a specific embodiment, a communication between a parking occupancy sensor and a vehicle is a radio transmission. That is, according to a specific embodiment a communication between vehicle and parking occupancy sensor includes a transmission of radio signals.

The identifier can in particular be designated an identification (ID). This is because it is used in particular for the identification of the motor vehicle.

According to a further specific embodiment, it is provided that the acquisition of the identifier includes the step that the parking occupancy sensor reads the identifier from an RFID chip situated on the motor vehicle.

In this way, in particular the technical advantage is brought about that the identifier can be efficiently acquired. In particular, this specific embodiment has the technical advantage that for this purpose for example no mobile radiotelephone network or WLAN communication network has to be set up. As a result, the technical implementation of this specific embodiment is correspondingly less costly in terms of outlay and time.

That is, on the motor vehicle there is situated an RFID chip that is read by the parking occupancy sensor. The identifier is stored in the RFID chip. That is, for example the license plate and/or the chassis number of the motor vehicle is stored in the RFID chip.

According to another specific embodiment, it is provided that the acquisition of the identifier includes recording an image of the motor vehicle, the identifier being acquired through an image analysis of the recorded image.

In this way, in particular the technical advantage is brought about that the identifier can be efficiently acquired. In particular, an identifier can also be acquired by motor vehicles that do not have an RFID chip having a stored identifier. The image analysis includes in particular the carrying out of a pattern recognition. That is, for example a search is made in the recorded image for a sequence of numbers and/or letters. This is because such a sequence of numbers and/or letters standardly corresponds to a license plate of the motor vehicle.

According to another specific embodiment, it is provided that the acquired identifier is sent to a testing server that tests whether the parked motor vehicle is permitted to park within the parking area.

In this way, in particular the technical advantage is brought about that the testing can be efficiently carried out. This is done by the testing server. This is because a testing server usually has computing capacity adequate to rapidly carry out a test without inordinately long wait times during the test.

According to a specific embodiment, it is provided that the reference identifiers are stored in the parking occupancy sensor, the testing including the carrying out of the testing by the parking occupancy sensor.

In this way, in particular the technical advantage is brought about that the testing can be efficiently carried out. In addition, this specific embodiment has the technical advantage that it functions independently of a testing server. This is because, for example, a testing server could fail or could be otherwise occupied. Nonetheless, a test can be carried out.

According to a specific embodiment, the reference identifiers are stored in the testing server.

According to a specific embodiment, the reference identifiers are stored in a database, so that the testing server reads the reference identifiers from the database for the purpose of testing.

According to a specific embodiment, the reference identifiers are stored in the parking occupancy sensor and/or in the testing server and/or in the database. In this way, a particularly redundant system is provided for operating a parking area.

According to a specific embodiment, it is provided that a communication between the parking occupancy sensor and the testing server is carried out via the communication network.

According to a specific embodiment, it is provided that the one action or the plurality of actions include the following actions:
sending a message via a communication network to an owner of the motor vehicle and/or to the person who has parked the motor vehicle at the parking space, stating that the motor vehicle has been impermissibly parked in the parking area;
displaying a message, using a display device situated within the parking area, stating that the motor vehicle has been impermissibly parked in the parking area;
sending a request via a communication network to an official stating that a ticket is to be issued to the parked motor vehicle;
sending an order via communication network to a towing company stating that this company is to tow away the parked motor vehicle;
sending an order via a communication network to a subscriber of the communication network stating that a wheel clamp is to be attached to a wheel of the motor vehicle. The subscriber is for example a business that attaches wheel clamps to wheels of motor vehicles.

The sending of the message to the owner of the motor vehicle or to the person who has parked the motor vehicle at the parking space brings about in particular the technical advantage that the owner, or the person, is efficiently informed that the motor vehicle is not permitted to park in the parking area. In this way, the owner and the person are given the possibility of themselves re-parking the motor vehicle, i.e., removing it from the parking area, before it is possibly towed away, which could be costly.

According to a specific embodiment, the message can for example be sent as a text message. According to a specific embodiment, the message includes a call to a device, in particular a mobile device of the owner or person.

The displaying of the message via the display device has in particular the technical advantage that the owner of the vehicle or the person who parked the vehicle at the parking space can be efficiently informed that the motor vehicle has been impermissibly parked in the parking area. This specific embodiment is therefore independent of a communication network for the purpose of sending a corresponding message to a device, in particular a mobile device, of the owner or person. In this way, in particular persons who are not themselves carrying a mobile device can also be correspondingly informed.

A display device includes for example a display screen and/or a warning sign.

The sending of the request to the authorities stating that a ticket is to be issued to the parked motor vehicle has in particular the technical advantage that the official can be efficiently informed about the impermissibly parked motor vehicle. In this way, the official can correspondingly react in an efficient manner and can send personnel to the parking space in order to issue a ticket for the parked motor vehicle. The official may be for example police and/or regulatory authorities.

The transmission of the order to the towing company has for example the technical advantage that the motor vehicle can be efficiently removed. In this way, in particular the technical advantage is brought about that the towing company can be efficiently informed about the impermissibly parked motor vehicle. Correspondingly, the possibility is thus created that, given a fast reaction on the part of the towing company, the parked motor vehicle is also towed away correspondingly quickly, and the parking space is thus freed for motor vehicles that are permitted to park in the parking area.

According to another specific embodiment, it is provided that at least one of the described method steps is documented. In particular, all of the method steps are documented.

In this way, in particular the technical advantage is brought about that even at a later time it can be understood exactly what was done, and how it was done. The documentation includes in particular electronic recording.

According to a specific embodiment, it is provided that one or more of the described method steps is carried out automatically.

According to a specific embodiment, it is provided that the system for operating a parking area is fashioned or set up to execute or carry out the method for operating a parking area. Technical functionalities of the system result analogously from corresponding technical functionalities of the method, and vice versa.

That is, the parking occupancy sensor or sensors is/are designed to acquire an identifier of the parked motor vehicle.

According to a specific embodiment, an environmental sensor system is provided that is capable of acquiring the parking area. Such an environmental sensor system includes for example one or more of the following environmental sensors: radar sensor, lidar sensor, laser sensor, ultrasound sensor, magnetic sensor, video sensor. In this way, an efficient sensor acquisition of the parking area is advantageously brought about. Based on the sensor acquisition, for example the identifier can be acquired, and/or a state of occupation of the parking spaces can be acquired.

According to a specific embodiment, the parking occupancy sensors include the following sensors: radar sensor, video sensor, laser sensor, ultrasound sensor, lidar sensor, magnetic sensor.

If a parking occupancy sensor is designed to acquire the identifier of the motor vehicle, that means in particular that the parking occupancy sensor includes sensors necessary for this purpose. Thus, for example the parking occupancy sensor includes a video sensor in order to record an image of the motor vehicle. For example, the parking occupancy sensor includes an antenna for communication with an RFID chip.

In a specific embodiment, it is provided that the identifier is sent from the motor vehicle itself via a communication network to a testing server that tests whether the parked motor vehicle is permitted to park within the parking area. In this way, in particular the technical advantage is brought about that the identifier can be checked independently of and/or in addition to a parking occupancy sensor. For example, it is provided that the driver of the motor vehicle triggers the sending of the identifier. In a further specific embodiment, it is provided that the motor vehicle automatically triggers the sending of the identifier as soon as the motor vehicle is parked.

Below, the present invention is explained in more detail on the basis of preferred exemplary embodiments.

### BRIEF DESCRIPTION OF THE DRAWINGS

FIG. 1 shows a flow diagram of a method for operating a parking area.

FIG. 2 shows a system for operating a parking area.

FIG. 3 shows a parking area.

### DETAILED DESCRIPTION OF EXAMPLE EMBODIMENTS

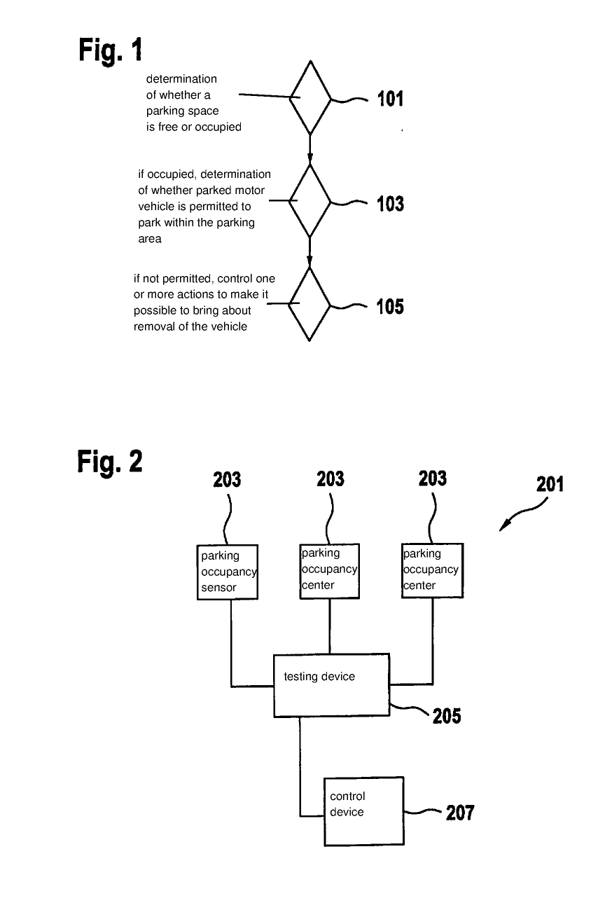

FIG. 1 shows a flow diagram of a method for operating a parking area that includes a plurality of parking spaces and a plurality of parking occupancy sensors for acquiring a respective state of occupation of the parking spaces.

The method includes the following steps:
determination 101, using a parking occupancy sensor, of whether a parking space is free or is occupied by a motor vehicle,
if the parking space is occupied by a motor vehicle, testing 103 of whether the parked motor vehicle is permitted to park within the parking area, and
if the motor vehicle is not permitted to park within the parking area, controlling 105 of one or more actions in order to make it possible to bring about a removal of the parked motor vehicle.

A parking area designates a spatially limited region within which a plurality of parking spaces are situated at which motor vehicles can park. The parking area is formed for example on public ground or on private ground.

FIG. 2 shows a system 201 for operating a parking area that includes a plurality of parking spaces.

System 201 includes:
a plurality of parking occupancy sensors 203 for acquiring a respective state of occupancy of the parking spaces in order to determine whether the parking spaces are free or are occupied by a parked motor vehicle,
a testing device 205 for testing, in case a parking space is occupied by a motor vehicle, whether the parked motor vehicle is permitted to park within the parking area,
a control device 207 for controlling one or more actions in order to make it possible to bring about a removal of the parked motor vehicle if the motor vehicle is not permitted to park within the parking area.

According to a specific embodiment, testing device 205 includes a plurality of testing subunits, one of the testing subunits being respectively situated in each of the plurality of parking occupancy sensors. In this way, the parking occupancy sensors are advantageously efficiently made capable of themselves being able to carry out the test.

The communication between parking occupancy sensors 203 and testing device 205 can be carried out for example via a communication network.

According to a specific embodiment, a communication between testing device 205 and control device 207 is likewise carried out via a communication network.

If testing device 205 includes a plurality of testing subunits included in parking occupancy sensors 203, then according to a specific embodiment it is provided that parking occupancy sensors 203 communicate via the communication network with control device 207 in order to communicate a result of the test thereto.

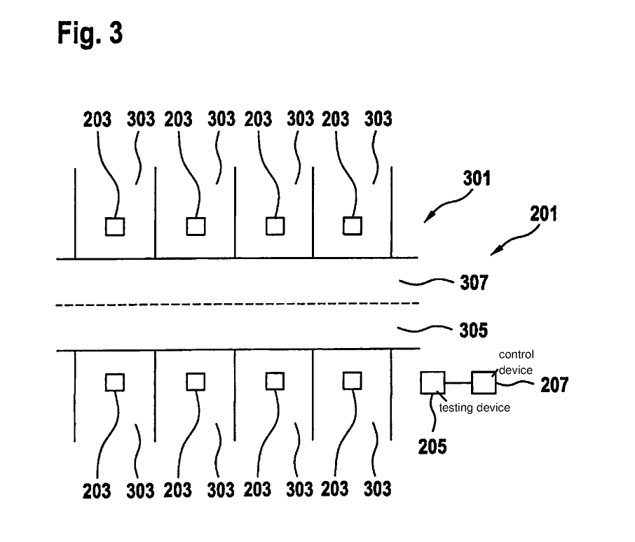

FIG. 3 shows a parking area 301.

Parking area 301 includes a plurality of parking spaces 303 at which motor vehicles can be parked. Parking spaces 303 are situated transverse to two driving lanes 305, 307.

Each of the parking spaces 303 includes a parking occupancy sensor 203. For example, parking occupancy sensors 203 are attached or situated on or under a roadway surface of parking spaces 303. In a specific embodiment that is not shown, parking occupancy sensors 203 are situated above parking spaces 303; for example, parking occupancy sensors 203 are situated on objects that are at a distance from the surface of parking spaces 303. Such objects are for example lampposts, utility poles, telephone poles, trees, or houses. For example, according to a specific embodiment it is provided that more or fewer parking occupancy sensors 203 are used than the number of parking spaces 303.

In addition, a testing device 205 and a control device 207 are provided, so that parking area 301 includes system 201 of FIG. 2. Therefore, reference is made to the corresponding statements.

During operation of parking area 301, it is now provided that a state of occupancy of the individual parking spaces 303 is acquired using parking occupancy sensors 203. If such a state of occupancy is an occupied state of occupancy, i.e. identifies an occupied parking space, it is then provided that, using testing device 205, it is tested whether the motor vehicle is permissibly parked within parking area 301. For this purpose, for example an identifier of the parked motor vehicle is acquired and is compared to reference identifiers. If it is determined that the parked motor vehicle is impermissibly parked, then control device 207 controls one or more actions in order to enable a removal of the parked motor vehicle.

The present invention thus includes, in particular and inter alia, providing an efficient technical design by which a management or operation of a parking area having freely selectable parking spaces, which in general can in particular each be realized as a parking bay, can be carried out. The present invention thus includes that, using parking occupancy sensors (for example ground sensors, roof sensors, camera-based systems), it can be determined whether a motor vehicle is situated at, i.e., parked at, the parking space, in particular the parking bay. In accordance with the present invention, it is tested whether for the parked motor vehicle there is a permit or reservation for this parking area, including the parking space, in particular the parking bay. That is, in general it is tested whether the parked motor vehicle is permitted to park within the parking area.

If there is no permit and/or reservation, actions are then preferably introduced in order in particular to bring about a removal of the motor vehicle.

That is, in particular it is not tested whether there is a permit and/or reservation for a particular parking space, but rather only for the parking area in general.

According to a specific embodiment, the test of permit and/or reservation is carried out on the basis of an unambiguous vehicle ID (vehicle identifier). The ID is for example the license plate or chassis number.

In a specific embodiment, the test is carried out by transmitting the ID from the vehicle to the parking occupancy sensor.

According to another specific embodiment, a transmission of the ID takes place through the reading of an RFID chip situated on the vehicle by the parking occupancy sensor.

According to another specific embodiment, the transmission of the ID between the motor vehicle and the parking occupancy sensor takes place via a communication channel (WLAN, mobile radiotelephone, radio transmission, e.g., LoRa communication network).

According to another specific embodiment, the ID is ascertained by a parking area infrastructure on the basis of the license plate using imaging methods (e.g., using a camera).

According to a specific embodiment, the ID is forwarded from the parking occupancy sensor and/or the imaging parking infrastructure to a parking area management system that includes the testing device, where the ID, and thus the permit and/or reservation, is tested.

Here the transmission can take place via various types of communication (cable, wireless via WLAN, radio, radiotelephone).

According to a specific embodiment, the authorized IDs (reference identifiers), and thus the corresponding motor vehicles, can also be stored in the parking occupancy sensors.

If there is no permit and/or reservation, then for example one or more of the following actions can be carried out:

Signal to the driver (via warning signs, call and/or text message to the mobile device of the driver, if known).

Issuing, or ordering the issuing of, a ticket, e.g., by communicating information to the police.

An order for the removal of the motor vehicle, for example by placing an order with a towing service or towing company.

A further action that is carried out is for example a documentation of the situation, in particular using a camera system, i.e., in particular visually, and/or of the action or actions taken.

According to a further specific embodiment, it is provided that all actions are introduced fully automatically. That is, they are introduced without manual action by service personnel.

1-14. (canceled)

15. A method for operating a parking area that includes a plurality of parking spaces and a plurality of parking occupancy sensors for acquiring a respective state of occupancy of each of the parking spaces, the method comprising:
determining, using a parking occupancy sensor, whether a parking space is free or is occupied by a motor vehicle;
if the parking space is occupied by a motor vehicle, testing whether the parked motor vehicle is permitted to park within the parking area; and
if the motor vehicle is not permitted to park within the parking area, controlling one or more actions to make it possible to bring about a removal of the parked motor vehicle.

16. The method as recited claim 15, wherein the testing includes acquiring an identifier of the parked motor vehicle, comparing the acquired identifier to reference identifiers of motor vehicles that are permitted to park within the parking area, and, based on the comparison, determining whether the parked motor vehicle is permitted to park within the parking area.

17. The method as recited in claim 16, wherein the identifier includes at least one of a license plate of the motor vehicle, and a chassis number of the motor vehicle.

18. The method as recited in claim 16, wherein the acquiring of the identifier includes receiving the identifier from the vehicle by the parking occupancy sensor.

19. The method as recited in claim 16, wherein the acquiring of the identifier includes reading out the identifier by the parking occupancy sensor from an RFID chip situated on the motor vehicle.

20. The method as recited in claim 16, wherein the acquiring of the identifier includes recording an image of the motor vehicle, the identifier being acquired by an image analysis of the recorded image.

21. The method as recited in claim 16, wherein the acquired identifier is sent to a testing server that tests whether the parked motor vehicle is permitted to park within the parking area.

22. The method as recited in claim 16, wherein the reference identifiers are stored in the parking occupancy sensor, the testing including carrying out of the testing by the parking occupancy sensor.

23. The method as recited in claim 16, wherein the identifier is sent by the motor vehicle itself, via a communication network, to a testing server, which tests whether the parked motor vehicle is permitted to park within the parking area.

24. The method as recited in claim 15, wherein the one or more actions including at least one of the following actions:
sending a message via a communication network to at least one of an owner of the motor vehicle, and a person who has parked the motor vehicle at the parking space, the message stating that the motor vehicle has been impermissibly parked in the parking area;
displaying a message, using a display device situated within the parking area, stating that the motor vehicle has been impermissibly parked in the parking area (301);
sending a request via a communication network to an official stating that a ticket is to be issued to the parked motor vehicle;
sending an order via a communication network to a towing company stating that the company is to tow away the parked motor vehicle;
sending an order via a communication network to a subscriber of the communication network stating that a wheel clamp is to be attached to a wheel of the motor vehicle.

25. The method as recited in claim 24, wherein at least one of the method steps is documented.

26. A system for operating a parking area that includes a plurality of parking spaces, the system comprising:
a plurality of parking occupancy sensors for acquiring a respective state of occupancy of each of the parking spaces to determine whether the parking spaces are free or are occupied by a parked motor vehicle;
a testing device for testing, when a parking space is occupied by a motor vehicle, whether the parked motor vehicle is permitted to park within the parking area; and
a control device for controlling one or more actions in order to make it possible to bring about a removal of the parked motor vehicle if the motor vehicle is not permitted to park within the parking area.

27. A parking area, comprising:
a plurality of parking spaces; and
a system for operating the parking area that includes a plurality of parking spaces, the system including a plurality of parking occupancy sensors for acquiring a respective state of occupancy of each of the parking spaces to determine whether the parking spaces are free or are occupied by a parked motor vehicle, a testing device for testing, when a parking space is occupied by a motor vehicle, whether the parked motor vehicle is permitted to park within the parking area, and a control device for controlling one or more actions in order to make it possible to bring about a removal of the parked motor vehicle if the motor vehicle is not permitted to park within the parking area.

28. A non-transitory computer-readable storage medium on which is stored a computer program including program code for operating a parking area that includes a plurality of parking spaces and a plurality of parking occupancy sensors for acquiring a respective state of occupancy of each of the parking spaces, the computer program, when executed by a processor, causing the processor to perform:
determining, using a parking occupancy sensor, whether a parking space is free or is occupied by a motor vehicle;
if the parking space is occupied by a motor vehicle, testing whether the parked motor vehicle is permitted to park within the parking area; and
if the motor vehicle is not permitted to park within the parking area, controlling one or more actions to make it possible to bring about a removal of the parked motor vehicle.
